(19) United States
(12) Patent Application Publication
(10) Pub. No.: US 2023/0314596 A1
(43) Pub. Date: Oct. 5, 2023

(54) EAR-REGION IMAGING

(71) Applicant: Meta Platforms Technologies, LLC, Menlo Park, CA (US)

(72) Inventors: Karol Constantine Hatzilias, Kenmore, WA (US); Ruobing Qian, Redmond, WA (US); Abhishek Sharma, Redmond, WA (US); Robin Sharma, Redmond, WA (US)

(21) Appl. No.: 17/709,964

(22) Filed: Mar. 31, 2022

(51) Int. Cl. G02B 27/01; H04N 5/232

(52) U.S. Cl. CPC G02B 27/0176; H04N 5/23219; G02B 2027/0178; G02B 2027/0138

(57) ABSTRACT

A transmitter emits transmit signals to an ear-region. Image signals are generated by a receiver. The image signals are generated by the receiver in response to receiving return signals. The return signals are the millimeter-wave transmit signals reflecting back from the ear-region. An ear-region image is generated in response to the image signals.

### TECHNICAL FIELD

This disclosure relates generally to optics, and in particular to imaging of an ear-region.

### BACKGROUND INFORMATION

A head mounted device is a wearable electronic device, typically worn on the head of a user. Head mounted devices may include one or more electronic components for use in a variety of applications, such as gaming, aviation, engineering, medicine, entertainment, activity tracking, and so on. Head mounted devices may include displays to present virtual images to a wearer of the head mounted device. When a head mounted device includes a display, it may be referred to as a head mounted display (HMD). Head mounted devices may be fitted to a particular user to increase performance or comfort of the head mounted device.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a top view of a user and an example system for imaging an ear-region of the user, in accordance with aspects of the disclosure.

FIG. 2 illustrates a front view of a user that includes a face-region and ear-regions, in accordance with aspects of the disclosure.

FIG. 3 illustrates a dimension between an ear saddle point and an eye feature, in accordance with aspects of the disclosure.

FIG. 4 illustrates an example head mounted device including a frame and arms, in accordance with aspects of the disclosure.

FIG. 5 illustrates an ear-region imaging process, in accordance with aspects of the disclosure.

### DETAILED DESCRIPTION

Embodiments of ear-region imaging are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1,000,000 nm includes near-infrared light. In aspects of this disclosure, near-infrared light may be defined as having a wavelength range of approximately 700 nm-1600 nm.

In aspects of this disclosure, the term “transparent” may be defined as having greater than 90% transmission of light. In some aspects, the term “transparent” may be defined as a material having greater than 90% transmission of visible light.

In some contexts, a proper fitting of a head mounted device improves comfort and/or performance of features of the head mounted device. For example, the performance of eye-tracking and virtual image presentation can be enhanced by a proper fitting of the head mounted device to a particular user. Furthermore, a proper fitting may assist in increasing the quality of a virtual experience by reducing an adaptation period of the user (if any). For head mounted device that are a head mounted display, yet another potential advantage of improving fit is to optionally design the near-eye display with a smaller eyebox that may be more efficient than a larger eye box near-eye display.

Achieving a good fit for a user may include components such as (1) physical comfort; (2) a properly positioned near-eye display (if any); (3) eye-tracking functionality; (4) and visual comfort. Achieving physical comfort may include distributing any pressure due to the weight of a head mounted device and stabilizing the head mounted device even with user movement. To properly position the near-eye display, the pupil(s) of the user will need to be in the eyebox that the near-eye display presents the virtual images to. Eye-tracking performance of the head mounted device (if any) may be improved by a correct eye-relief between the eye of the user and the components of the eye-tracking system in a frame and/or temple arm of a head mounted device. Visual comfort of the user may entail centering a prescription lens included in the head mounted device with respect to the pupils of the user.

To assist in providing a high quality fit of the head mounted device, measurements of the user such as nose shape, head breadth, and ear depth may need to be measured. The features of an ear of a specific user may be particularly important if the head mounted device sits or rests above the ear, when worn. An ear saddle point is the point where the arm of the head mounted device would rest when the user is wearing the head mounted device. The ear saddle point may correspond with an inflection point where ear hooks of an arm of a head mounted device contacts the ear. Conventional measurement systems (e.g. camera systems) provide acceptable measurements for a facial region of a user to fit a head mounted device, but struggle to accurately image/measure the ear-region due to hair occluding the top and back of the ear—and the ear saddle point in particular. Therefore, the fit of a head mounted device may be improved by an improved ear-region imaging system.

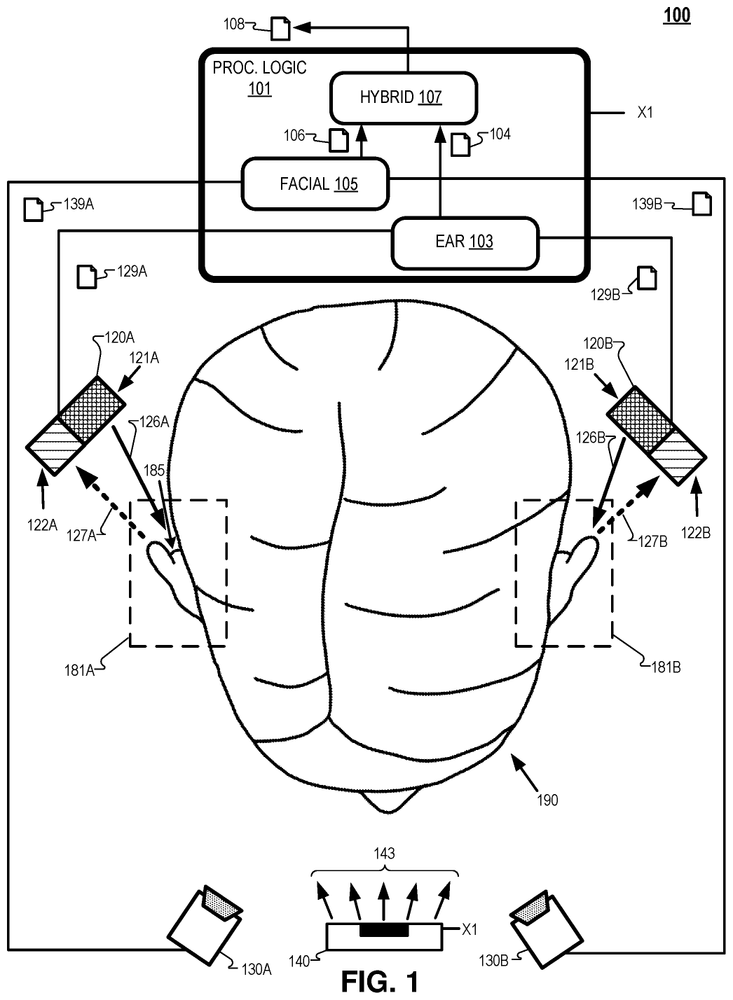

Implementations of devices, systems, and methods of ear-region imaging are disclosed herein. A transmitter emits transmit signals to an ear-region. The transmit signals may be millimeter-wave (also known as “mmWave”), ultrasound, or other transmit signals that propagate through hair. A receiver receives the return signals that are the transmit signals reflecting/scattering off the ear in the ear-region. The receiver generates image signals from the return signals and an ear-region image is generated in response to the image signals. The ear-region image may be combined with a facial image of a face-region of the user to generate a hybrid face-ear image. The hybrid face-ear image may share a common coordinate system so that various dimensions between the eye and face of the user with respect of the user can be extracted from the hybrid face-ear image for fitting of the head mounted device. These and other embodiments are described in more detail in connections with FIGS. 1-5.

FIG. 1 illustrates a top view of a user 190 and an example system 100 for imaging an ear-region of the user, in accordance with aspects of the disclosure. Example system 100 includes transducers 120A and 120B (collectively referred to as transducers 120), light imaging systems 130A and 130B (collectively referred to as light imaging systems 130), and processing logic 101. In some implementations, system 100 includes one transducer 120 and processing logic 101 and light imaging system(s) 130 are optional. In various implementations, system 100 may include a single transducer 120 and a single light imaging system 130, although any number of transducers 120 and light imaging systems 130 can be combined in systems of the disclosure.

Transducer 120A includes a transmitter 121A configured to emit transmit signals 126A to ear-region 181A of user 190 and a receiver 122A configured to receive return signals 127A. The return signals 127A are the transmit signals 126A reflecting/scattering from ear-region 181A. Similarly, transducer 120B includes a transmitter 121B configured to emit transmit signals 126B to ear-region 181B of user 190 and a receiver 122B configured to receive return signals 127B. The return signals 127B are the transmit signals 126B reflecting/scattering from ear-region 181B.

The transmit signals 126A and 126B (collectively referred to as transmit signals 126) penetrate hair and reflect off of human skin. Hence, if hair occludes the skin of the ear, transmit signals 126 propagate through the hair, reflect/scatter off the skin of the ear and then propagate back through the hair to receiver 122 as return signal 127. An ear saddle point 185 of the ear of user 190 is indicated in ear-region 181A. While not specifically illustrated, the ear occupying ear-region also includes an ear saddle point. As discussed above, an ear saddle point may be an important point for proper fitting of head mounted devices to a particular user.

Transmit signals 126 are not visible light nor infrared light since visible light and infrared light may be occluded by hair covering the ear. In some implementations, transmit signals may be millimeter-wave transmit signals having a wavelength between 1 mm and 10 mm in the electromagnetic spectrum. Millimeter-wave transducers/chips may be commonly available from the autonomous vehicle industry or airport security industry, for example. In implementations, transmit signals 126 may be ultrasound or X-ray transmit signals.

In operation, processing logic drives transmitter(s) 121 to emit transmit signals(s) 126 to ear-region(s) 181. Receivers 122A and 122B receive return signals 127A and 127B, respectively, and generate image signals 129A and 129B (also respectively) in response to receiving return signals 127A and 127B. Return signals 127A and 127B may be referred to collectively as return signals 127 and image signals 129A and 129B may be referred to collectively as image signals 129. Processing logic 101 receives the image signals 129 from the receiver(s) 122 of the transducers(s) and generate an ear-region image 104 in response to the image signals 129.

In the illustrated implementation, processing logic 101 includes an ear-image generation module 103 that receives image signals 129 and generates ear-region image 104 by processing image signals 129. When system 100 includes a light imaging system(s) 130, light imaging system 130 may capture a facial image 139 of the face-region of user 190 by sensing visible or non-visible light 143 reflecting back from the face-region.

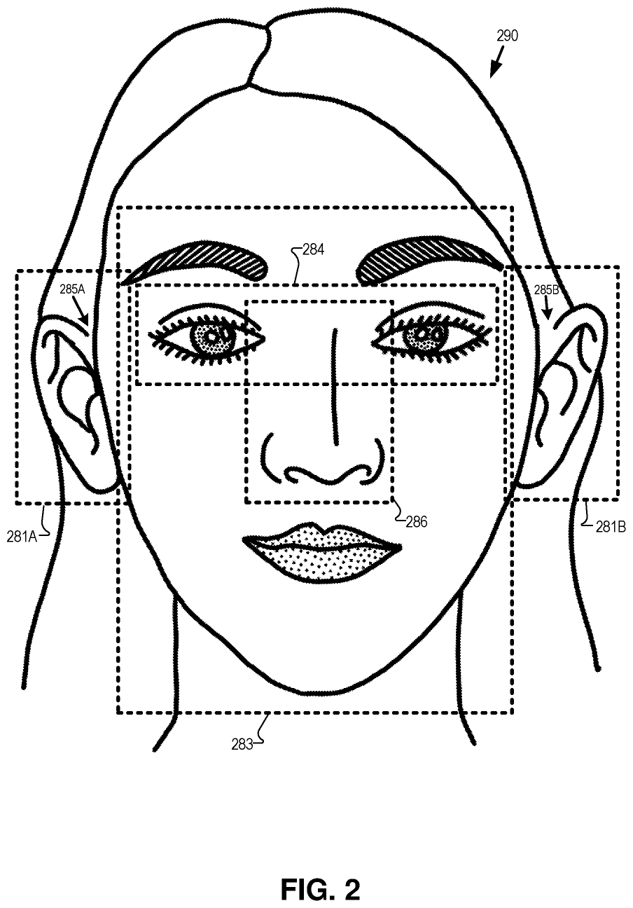

FIG. 2 illustrates a front view of a user 290 that includes a face-region 283 and ear-regions 281A and 281B, in accordance with implementations of the disclosure. Light imaging system 130 of FIG. 1 may be configured to generate one or more facial images 139 that image face-region 283. In the specific example illustration, face-region 283 includes eye-region 284 and nose-region 286 of user 290. Features of the eyes and nose may assist in determining a comfortable fit for a head mounted device for a particular user 290. In FIG. 2, face region 283 overlaps ear-regions 281A and 281B. An approximate location of ear saddle point 285A is indicated in right ear-region 281A and an approximate location of ear saddle point 285B is indicated in left ear-region 281B.

Returning to FIG. 1, light imaging system 100 is configured to capture facial image 139 of face-region 283 by sensing visible or non-visible light reflecting back from the face-region 283. In some implementations, an illumination module 140 may be oriented to illuminate face-region 283 with illumination light 143. Illumination module 140 may include light sources such as LEDs or laser sources. Illumination light 143 may be visible or infrared light. Light imaging system 130 may include one or more complementary metal-oxide semiconductor (CMOS) image sensors. In an implementation where illumination light 143 is infrared light, an infrared filter that receives a narrow-band infrared wavelength may be placed over the image sensor so it is sensitive to the narrow-band infrared wavelength of illumination light 143 while rejecting visible light and wavelengths outside the narrow-band. In the illustrated implementation, processing logic 101 is configured to selectively activate and deactivate (turn on and off) illumination module 140 by way of communication channel X1 so that illuminating user 190 with illumination light 143 corresponds with an image capture of light imaging system(s) 130.

Processing logic 101 is configured to receive facial images 139A and 139B (collectively referred to as facial images 139) of face-region 283. Facial images 139 may include columns and rows of pixels. Processing logic 101 receives the facial image(s) 139 from the light imaging system 130. Processing logic 101 may generate a hybrid face-ear image 108 that includes the facial image(s) 139 and the ear-region image(s) 104. In the particular example illustration of FIG. 1, processing logic 101 includes a combined facial image generation module 105 that generates a combined facial image 106 that includes facial images 139A and 139B. In other implementations, facial images 139 are routed directly to hybrid image generation module 107 and hybrid image generation module 107 generates hybrid face-ear image 108 from facial image(s) 139 and ear-region image 104. The facial image(s) 139 may share a common coordinate system with ear-region image 104 in imaging space so that hybrid image generation module 107 can generate hybrid face-ear image 108 where the locations in the ear-region image 104 are linked to locations in the facial images 139.

While FIG. 1 illustrates one transmitter 121 and one receiver 122 per transducer 120, implementations of transducer 120 include arrays of transmitters 121 to achieve beam-forming of the transmit signals 126. In this way, transmit signals 126 may be steered to various positions of the ear-region 181 for imaging purposes. In an implementation, transducer 120 includes a two-dimensional (2D) array of transmitters 121 that generate a patterned illumination of ear-region 181 with transmit signals 126. In an implementation, transducer 120 includes a 2D array of transmitters 121 that sweeps transmit signals 126 across ear-region 181. In an implementation, transducer 120 includes a one-dimensional array of transmitters 121 that sweeps transmit signals 126 across ear-region 181. In an implementations, receiver 122 includes a photodiode and transmitter 121 includes a mechanically steered source to steer transmit signals 126 within ear-region 181. Receiver 122 may include a 2D array of receive elements.

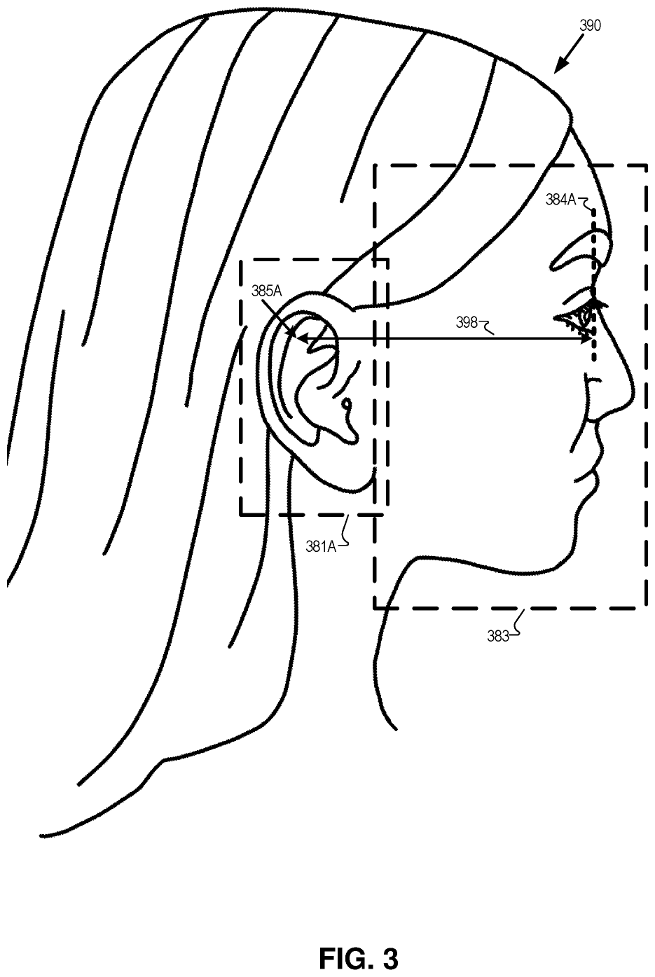

FIG. 3 illustrates a dimension 398 between ear saddle point 385A and an eye feature, in accordance with aspects of the disclosure. FIG. 3 illustrates ear saddle point 385 (located behind the ear in ear-region 381A) may be occluded from light-based imaging by the hair of person 390. However, using transmit signals 126 that propagate through the hair to image the ear saddle point 385A provides an accurate imaging of ear saddle point 385A that can then be used to determine dimension 398 between ear saddle point 385A and an eye feature. For example, if hybrid face-ear image 108 includes a facial image of face-region 383 and ear-region 381A sharing a common coordinate system, dimension 398 can be calculated from the hybrid face-ear image 108. In the illustrated implementation of FIG. 3, the eye feature is a cornea plane. In some implementations, the eye feature is a pupil plane.

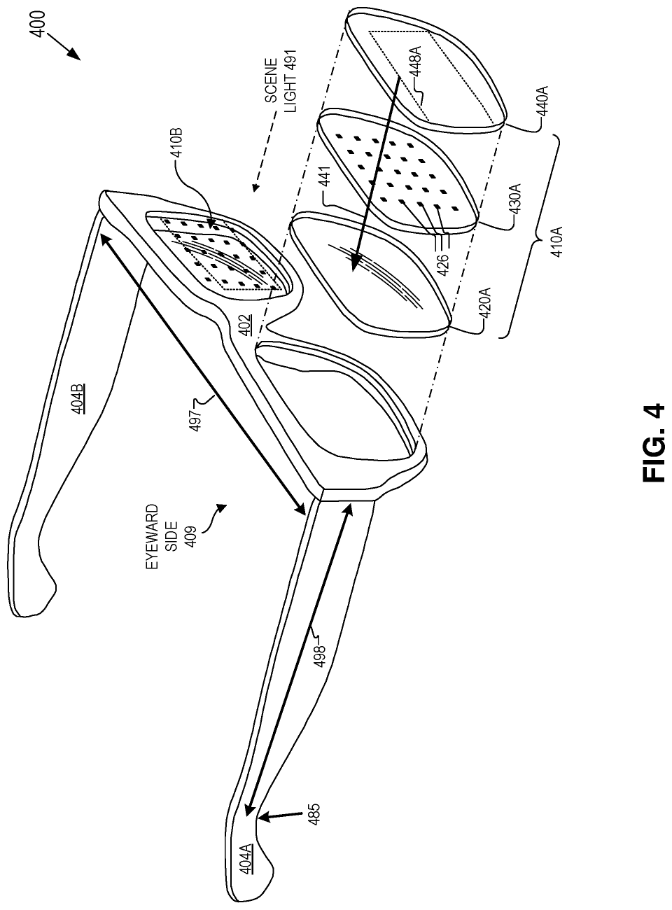

FIG. 4 illustrates an example head mounted device 400 including a frame 402 and arms 404A and 404B, in accordance with implementations of the disclosure. The illustrated example of head mounted device 400 is shown as including a frame 402, temple arms 404A and 404B, and near-eye optical elements 410A and 410B. For proper fitting of a head mounted device 400 to a person 390, a dimension 498 of the temple arm 404A may be selected based on the dimension 398 of FIG. 3. Dimension 498 runs from an inflection point 485 on temple arm 404A that will rest on an ear saddle point of a user. Dimension 498 may be slightly longer than dimension 398 to provide eye-relief between an eye of a user and an optical element 410A of the head mounted device 400. A head breadth dimension 497 of frame 402 may also be selected for a user based on a head breadth measurement of a user that is derived from a hybrid face-ear image (e.g. image 108).

FIG. 4 illustrates an exploded view of an example of near-eye optical element 410A. Near-eye optical element 410A is shown as including an optically transparent layer 420A, an illumination layer 430A, and a display layer 440A. Display layer 440A may include a waveguide 448A that is configured to direct virtual images included in visible image light 441 to an eye of a user of head mounted device 400 that is in an eyebox region of head mounted device 400. Thus, a proper fitting of head mounted device 400 enhances a user experience in viewing the virtual images included in visible image light 441 when the fit of the head mounted device 400 allows the virtual images to be presented more accurately to where the eye of the user is positioned with respect to display layer 440A. In some implementations, at least a portion of the electronic display of display layer 440A is included in the frame 402 of head mounted device 400. The electronic display may include an LCD, an organic light emitting diode (OLED) display, micro-LED display, pico-projector, or liquid crystal on silicon (LCOS) display for generating the image light 441.

When head mounted device 400 includes a display, it may be considered a head mounted display. Head mounted device 400 may be considered an augmented reality (AR) head mounted display. While FIG. 4 illustrates a head mounted device 400 configured for augmented reality (AR) or mixed reality (MR) contexts, the disclosed embodiments may also be used in other implementations of a head mounted display such as virtual reality head mounted displays. Additionally, some implementations of the disclosure may be used in a head mounted device that do not include a display.

Illumination layer 430A is shown as including a plurality of in-field illuminators 426. In-field illuminators 426 are described as “in-field” because they are in a field of view (FOV) of a user of the head mounted device 400. In-field illuminators 426 may be in a same FOV that a user views a display of the head mounted device 400, in an embodiment. In some aspects of the disclosure, the in-field illuminators 426 are configured to emit near infrared light that assist with eye-tracking. Each in-field illuminator 426 may be a micro light emitting diode (micro-LED), an edge emitting LED, a vertical cavity surface emitting laser (VCSEL) diode, or a Superluminescent diode (SLED). In some implementations, illuminators 426 are not in-field. Rather, illuminators 426 could be out-of-field in some implementations.

As shown in FIG. 4, frame 402 is coupled to temple arms 404A and 404B for securing the head mounted device 400 to the head of a user. Example head mounted device 400 may also include supporting hardware incorporated into the frame 402 and/or temple arms 404A and 404B. The hardware of head mounted device 400 may include any of processing logic, wired and/or wireless data interface for sending and receiving data, graphic processors, and one or more memories for storing data and computer-executable instructions. In one example, head mounted device 400 may be configured to receive wired power and/or may be configured to be powered by one or more batteries. In addition, head mounted device 400 may be configured to receive wired and/or wireless data including video data.

Optically transparent layer 420A is shown as being disposed between the illumination layer 430A and the eyeward side 409 of the near-eye optical element 410A. The optically transparent layer 420A may receive the infrared illumination light emitted by the illumination layer 430A and pass the infrared illumination light to illuminate the eye of the user. As mentioned above, the optically transparent layer 420A may also be transparent to visible light such as scene light received from the environment and/or image light 441 received from the display layer 440A. In some examples, the optically transparent layer 420A has a curvature for focusing light (e.g., display light and/or scene light) to the eye of the user. Thus, the optically transparent layer 420A may, in some examples, may be referred to as a lens. In some aspects, the optically transparent layer 420A has a thickness and/or curvature that corresponds to the specifications of a user. In other words, the optically transparent layer 420A may be a prescription lens. However, in other examples, the optically transparent layer 420A may be a non-prescription lens. When optically transparent layer 420 has optical power, improved fitting of head mounted device 400 allows the center of the lens to correspond with the pupil position of the user so that image light 441 and/or scene light 491 is properly focused to the pupil.

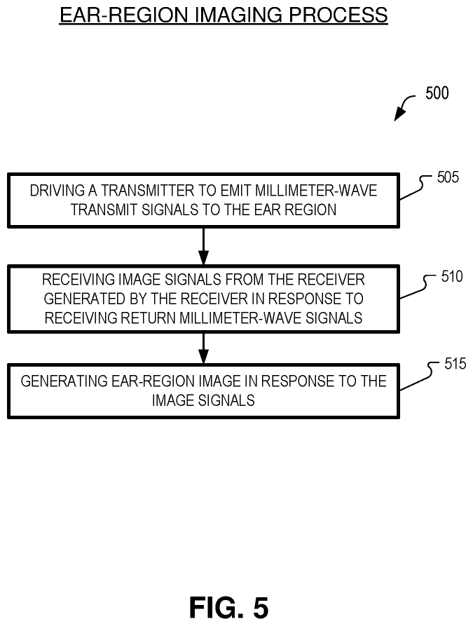

FIG. 5 illustrates an ear-region imaging process 500, in accordance with aspects of the disclosure. The order in which some or all of the process blocks appear in process 500 should not be deemed limiting. Rather, one of ordinary skill in the art having the benefit of the present disclosure will understand that some of the process blocks may be executed in a variety of orders not illustrated, or even in parallel. In some implementations, processing logic 101 of FIG. 1 executes all or a portion of process 500.

In process block 505, a transmitter is driven to emit millimeter-wave transmit signals (e.g. transmit signals 126) to an ear-region. The millimeter-wave transmit signals may have a wavelength between 1 mm and 10 mm. The ear-region image may include an ear saddle point. In an implementation, the transmitter includes a two-dimensional array of transmitter elements and driving the transmitter to emit the millimeter-wave transmit signals includes driving the transmitter elements to beam-form the millimeter-wave transmit signals to steer the millimeter-wave transmit signals to the ear-region.

In process block 510, image signals are received from a receiver (e.g. receiver 122). The image signals are generated by the receiver in response to receiving return millimeter-wave signals. The return millimeter-wave signals are the millimeter-wave transmit signals reflecting back from the ear-region.

In process block 515, an ear-region image is generated in response to the image signals.

An implementation of process 500 further includes capturing a facial image of a face-region of the person by sensing visible or non-visible light reflecting back from the face-region and generating a hybrid face-ear image that includes the facial image and the ear-region image. The face-region may include an eye-region and a nose-region. The facial image may share a common coordinate system with the ear-region image in imaging space. Process 500 may further include determining a dimension from the hybrid face-ear image where the dimension is between an ear saddle point and a cornea-plane of an eye of the user.

In an implementation of process 500, prior to executing process block 505, an ear-region of a person is identified based on position images of the person. This may allow the millimeter-wave transmit signals to be directed to a location to image the ear. In an implementation, cameras included in light imaging system(s) 130 are used to capture the position images of the person so that the ear-region (e.g. 181) of the person can be determined with respect to transducers 120.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 101) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, BlueTooth, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A system for imaging an ear-region comprising:
a transmitter configured to emit millimeter-wave transmit signals;
a receiver configured receive return millimeter-wave signals; and
processing logic configured to:
drive the transmitter to emit the millimeter-wave transmit signals to an ear-region;
receive image signals from the receiver, wherein the image signals are generated by the receiver in response to receiving the return millimeter-wave signals, the return millimeter-wave signals being the millimeter-wave transmit signals reflecting back from the ear-region; and
generating an ear-region image in response to the image signals, wherein the ear-region includes an ear saddle point.

2. The system of claim 1 further comprising:
a light imaging system configured to capture a facial image of a face-region by sensing visible or non-visible light reflecting back from the face-region, the face-region including an eye-region and a nose-region, wherein the face-region overlaps the ear-region, and wherein the processing logic is further configured to:
receive the facial image from the light imaging system; and
generate a hybrid face-ear image that includes the facial image and the ear-region image, wherein the facial image shares a common coordinate system with the ear-region image in imaging space.

3. The system of claim 2, wherein the hybrid face-ear image includes a dimension between the ear saddle point and an eye feature of an eye of a user.

4. The system of claim 1, wherein the millimeter-wave transmit signals have a wavelength between 1 mm and 10 mm.

5. (canceled)

6. The system of claim 1, wherein the transmitter includes a two-dimensional array of transmitter elements, and wherein driving the transmitter to emit the millimeter-wave transmit signals includes driving the transmitter elements to beam-form the millimeter-wave transmit signals to steer the millimeter-wave transmit signals to the ear-region.

7. The system of claim 1, wherein the receiver includes a two-dimensional array of receive elements.

8. The system of claim 1, wherein driving the transmitter to emit the millimeter-wave transmit signals includes driving the transmitter to sweep the millimeter-wave transmit signals across the ear-region.

9. The system of claim 1 further comprising:
a second transmitter configured to emit second millimeter-wave transmit signals; and
a second receiver configured receive second return millimeter-wave signals, the second return millimeter-wave signals being the second millimeter-wave transmit signals reflecting back from a second ear-region.

10. The system of claim 9, wherein the second ear-region is a left ear-region and the ear-region is a right ear-region.

11. The system of claim 1 further comprising:
a camera configured to capture one or more position images, wherein the processing logic is further configured to:
receive the one or more position images from the camera; and
identify an ear-region of a person based on the one or more of the position images.

12. A system for imaging an ear-region comprising:
a transmitter configured to emit transmit signals, wherein the transmit signals are neither visible light nor non-visible light;
a receiver configured receive return signals;
a light imaging system configured to capture a facial image of a face-region by sensing visible or non-visible light reflecting back from the face-region, the face-region including an eye-region and a nose-region, wherein the face-region overlaps the ear-region; and
processing logic configured to:
drive the transmitter to emit the transmit signals to an ear-region;
receive image signals from the receiver, wherein the image signals are generated by the receiver in response to receiving the return signals, the return signals being the transmit signals reflecting back from the ear-region;
generating an ear-region image in response to the image signals;
receive the facial image from the light imaging system; and
generate a hybrid face-ear image that includes the facial image and the ear-region image, wherein the facial image shares a common coordinate system with the ear-region image in imaging space.

13. The system of claim 12, wherein the transmit signals are ultrasound signals.

14. A method comprising:
driving a transmitter to emit millimeter-wave transmit signals to an ear-region;
receiving image signals from a receiver, wherein the image signals are generated by the receiver in response to receiving return millimeter-wave signals, the return millimeter-wave signals being the millimeter-wave transmit signals reflecting back from the ear-region; and
generating an ear-region image in response to the image signals, wherein the ear-region includes an ear saddle point.

15. The method of claim 14 further comprising:
capturing a facial image of a face-region of a person by sensing visible or non-visible light reflecting back from the face-region, the face-region including an eye-region and a nose-region, wherein the face-region overlaps the ear-region; and
generating a hybrid face-ear image that includes the facial image and the ear-region image, wherein the facial image shares a common coordinate system with the ear-region image in imaging space.

16. The method of claim 15 further comprising:
determining a dimension from the hybrid face-ear image, wherein the dimension is between the ear saddle point and a pupil-plane of an eye of a user.

17. The method of claim 14, wherein the millimeter-wave transmit signals have a wavelength between 1 mm and 10 mm.

18. (canceled)

19. The method of claim 14, wherein the return millimeter-wave signals propagated through hair prior to encountering the receiver.

20. The method of claim 14 further comprising:
identifying an ear-region of a person based on position images of the person.

21. The system of claim 12, wherein the hybrid face-ear image includes a dimension between an ear saddle point and an eye feature of an eye of a user.
